(19) United States
(12) Patent Application Publication
(10) Pub. No.: US 2019/0307076 A1
(43) Pub. Date: Oct. 10, 2019

(54) Collapsible Planting Pot

(71) Applicant: Rosanna Lerum Smith, Jacksonville, FL (US)

(72) Inventor: Rosanna Lerum Smith, Jacksonville, FL (US)

(21) Appl. No.: 16/378,259

(22) Filed: Apr. 8, 2019

Related U.S. Application Data
(60) Provisional application No. 62/653,978, filed on Apr. 6, 2018.

(51) Int. Cl. A01G 9/02; A01G 9/04

(52) U.S. Cl. CPC A01G 9/026; A01G 9/042

(57) ABSTRACT

A collapsible planting pot allows a user to easily and conveniently access and/or remove contents placed inside a planting pot. In further detail, a user does not need to destroy or damage the planting pot to fully access and/or remove the soil and plant substance placed inside a planting pot. The collapsible planting pot comprises a pot body. The pot body is a pot-shaped structure that is used to store soil and a plant substance. The pot body comprises a brim, a series of annular pleats, and a base. The brim is the protective edge of the pot body. The base is the structural foundation of the pot body. The series of annular pleats is a set of foldable sections of the pot body which enables the collapsibility of the collapsible planting pot which further allows a user to easily access and/or remove the contents inside the pot body.

The current application claims a priority to the U.S. Provisional Patent application Ser. No. 62/653,978 filed on Apr. 6, 2018. The current application is filed on Apr. 8, 2019 while Apr. 6, 2019 was on a weekend.

### FIELD OF THE INVENTION

The present invention generally relates to a pot used for holding plants of various species. The present invention is a planting pot that can be folded down to a collapsed configuration in order to access and/or remove the contents inside the planting pot.

### BACKGROUND OF THE INVENTION

Plant pots are a commonplace in any household that features flowers or plants. Pots allow the user to contain the components of the plant, especially the soil, to allow the plant to thrive while keeping the area around the plant clean. Many pots include a water reservoir that hold excess water for the plant to use as needed. When a user pours water into the soil, the plant will absorb whatever is needed, while the excess will travel downwards and collect at the bottom of the pot. An issue with current designs of plant pots is that once a plant and the soil are dumped into the pot, it is difficult to replace the soil or remove the soil and the plant without soil spilling onto the ground. The user needs to be careful to ensure that they pull the plant and soil without damaging the roots while also not spilling the soil.

An objective of the present invention is to provide an easier method for removing the contents of a plant pot. The present invention features a foldable design such that the sides of the invention can be folded down to allow the user to access the sides of the plant and soil. The user simply pushes the top rim of the pot down until the subsequent layers of foldable material collapse into one layer. The lowermost layer includes an internal water reservoir that holds the excess water. Once the present invention has been collapsed, the user can pick up the soil and plant to transport to another location. The user can then pull up on the rim of the pot to unfold the layers back into a pot configuration.

### BRIEF DESCRIPTION OF THE DRAWINGS

FIG. 1 is a front perspective view of the present invention in the operative configuration.

FIG. 2 is a front view of the present invention in the operative configuration.

FIG. 3 is a top perspective view of the present invention in the operative configuration displaying the reservoir tray within the pot body.

FIG. 4 is a front perspective view of the present invention in the collapsed configuration.

FIG. 5 is a front view of the present invention in the collapsed configuration.

FIG. 6 is a cross-sectional view of section 6-6 from FIG. 5.

FIG. 7 is a front perspective view of an exemplary embodiment of the present invention in the operative configuration.

FIG. 8 is a front view of an exemplary embodiment of the present invention in the operative configuration.

FIG. 9 is a cross-sectional view of section 9-9 from FIG. 8.

FIG. 10 is a front perspective view of the reservoir tray.

### DETAIL DESCRIPTIONS OF THE INVENTION

All illustrations of the drawings are for the purpose of describing selected versions of the present invention and are not intended to limit the scope of the present invention.

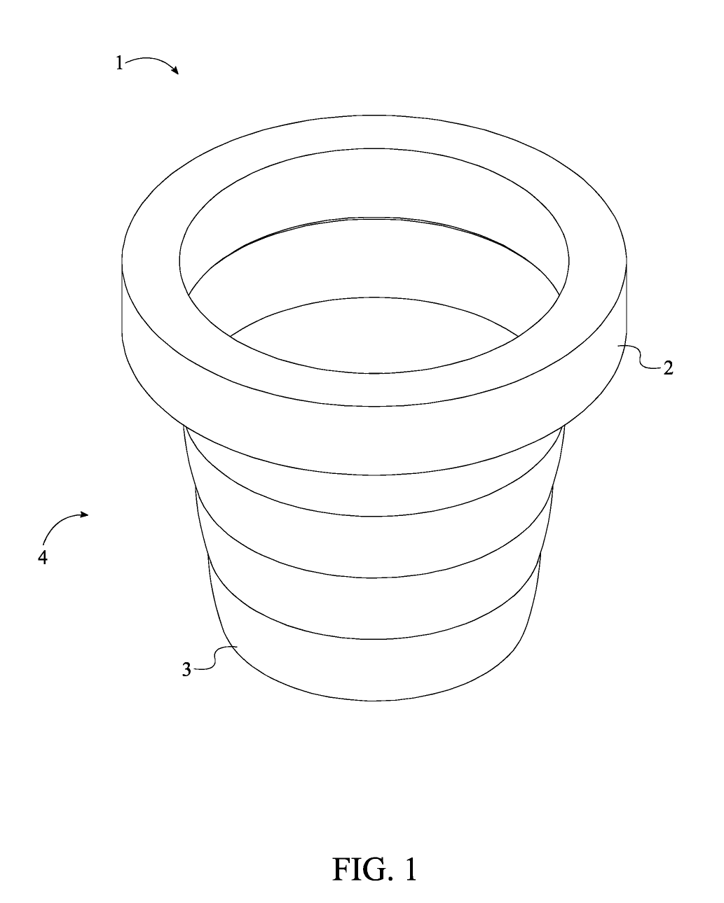

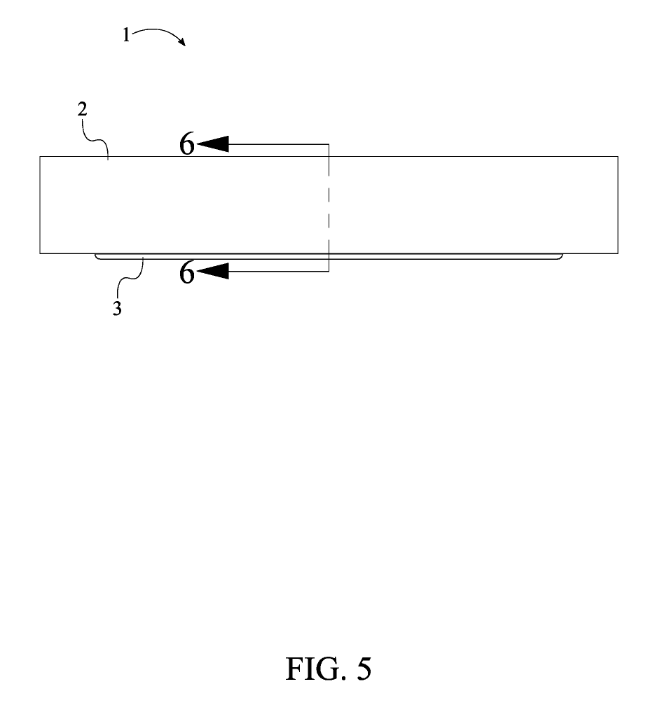

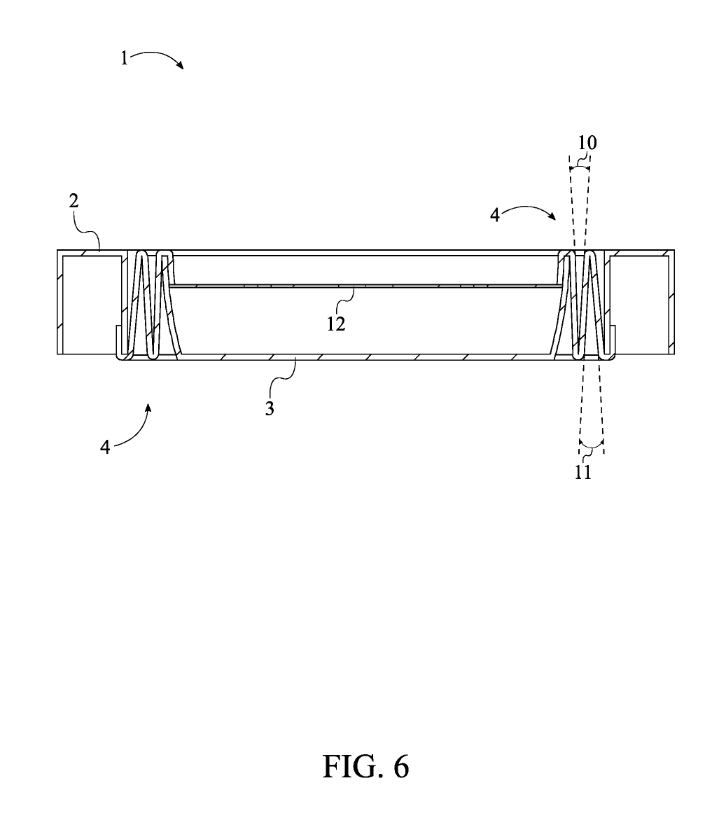

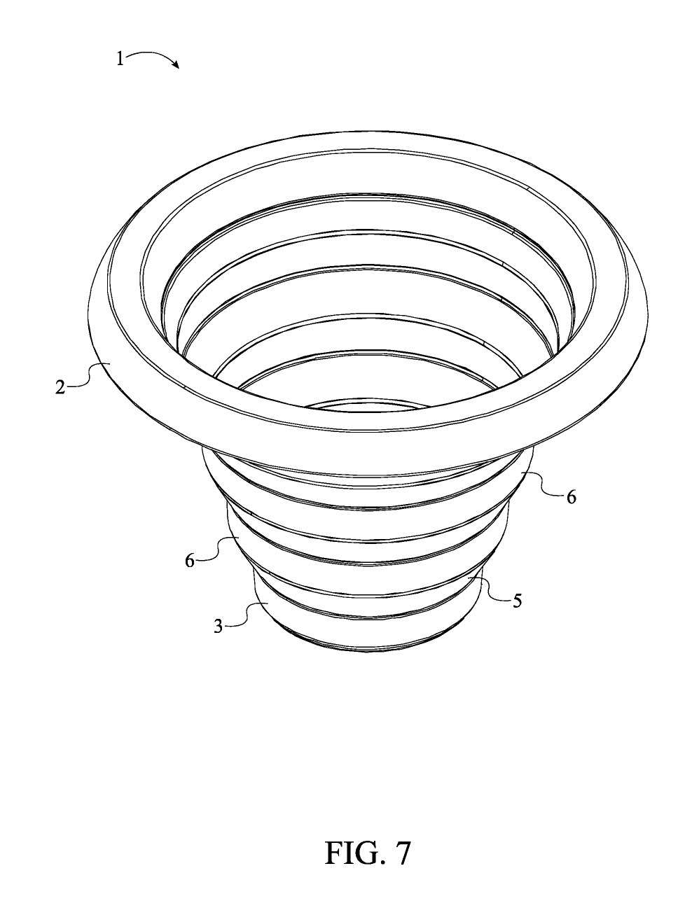

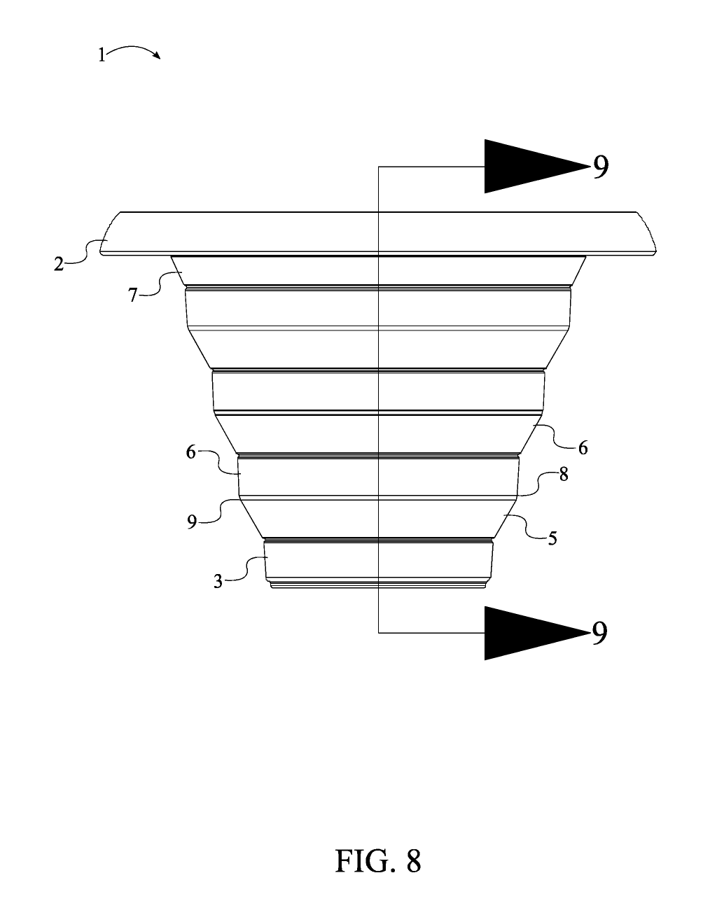

In reference to FIGS. 1 through 10, the present invention is a collapsible planting pot that allows a user to easily access and/or remove the contents inside the planting pot.

In further detail, the present invention allows a user to easily transport the soil and plant placed in the planting pot to another location without destroying the planting pot. With reference to FIG. 1, the present invention comprises a pot body 1. The pot body 1 is a pot-shaped structure used to contain soil and plant substances. The pot body 1 may be composed of any material and may be of any size. The pot body 1 comprises a brim 2, a base 3, and a series of annular pleats 4. The brim 2 is the protective edge of the pot body 1. The base 3 is the structural foundation of the pot body 1. The series of annular pleats 4 is a set of foldable sections of the pot body 1 which enables the collapsibility of the present invention.

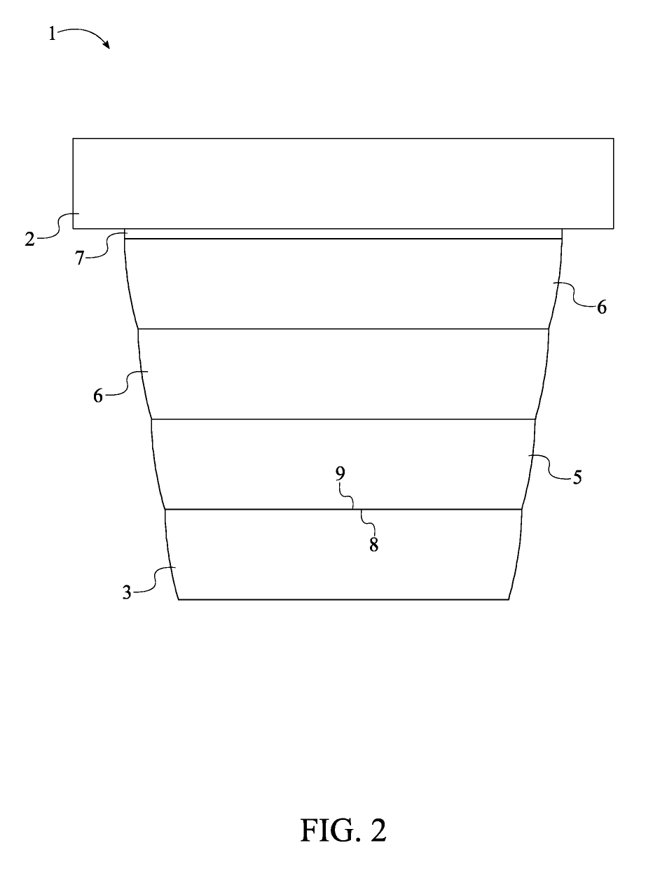

The general configuration of the aforementioned components allows the pot body 1 to be conveniently collapsed by the user in order to access and/or remove the contents placed inside the pot body 1. With reference to FIG. 2, the series of annular pleats 4 comprises a beginning pleat 5, a plurality of intermediate pleats 6, and an ending pleat 7. The beginning pleat 5 is the smallest lowest pleat of the pot body 1 when in an upright position. Each of the plurality of intermediate pleats 6 proceeds the beginning pleat 5 and is gradually larger than a preceding pleat along the pot body 1 when in an upright position. The ending pleat 7 is the largest and highest pleat of the pot body 1 when in an upright position. Each of the series of annular pleats 4 comprises a first rim 8 and a second rim 9. The first rim 8 and the second rim 9 are edges of each of the series of annular pleats 4. The second rim 9 is larger than the first rim 8 for each of the series of annular pleats 4. The first rim 8 of the beginning pleat 5 is perimetrically and foldably connected around the base 3 in order to allow the beginning pleat 5 to be collapsed towards the base 3. The first rim 8 of an arbitrary intermediate pleat is foldably connected along the second rim 9 of a preceding annular pleat from the series of annular pleats 4. The arbitrary intermediate pleat is any pleat from the plurality of intermediate pleats 6. The second rim 9 of the arbitrary intermediate pleat is foldably connected along the first rim 8 of a subsequent annular pleat from the series of annular pleats 4. The second rim 9 of the ending pleat 7 is perimetrically and foldably connected around the brim 2. In further detail, the first rim 8 of each intermediate pleat is connected to the second rim 9 of a lower pleat along the pot body 1 in an upright position. This arrangement starts from the beginning pleat 5 towards the ending pleat 7 along the pot body 1 in an upright position. Moreover, the beginning pleat 5 is the initial preceding annular pleat and the ending pleat 7 is the final subsequent annular pleat.

With reference to FIGS. 1, 2, 7 and 8, the pot body 1 may be arranged into an operative configuration. The operative configuration is where the pot body 1 is fully extended in an upright position in order to hold soil and a plant substance. In the operative configuration, the brim 2 and the base 3 are positioned offset from each other. Moreover, the series of annular pleats 4 is positioned in between the brim 2 and the base 3. This arrangement properly positions the parts of the pot body 1 in order for the pot body 1 to hold soil and a plant substance. A user may arrange the pot body 1 into the operative configuration by holding down the base 3 and extending the pot body 1 by pulling the brim 2 away from the base 3. Furthermore, the pot body 1 tapers from the brim 2 to the base 3 in order for the pot body 1 in the operative configuration to portray the conventional pot shape.

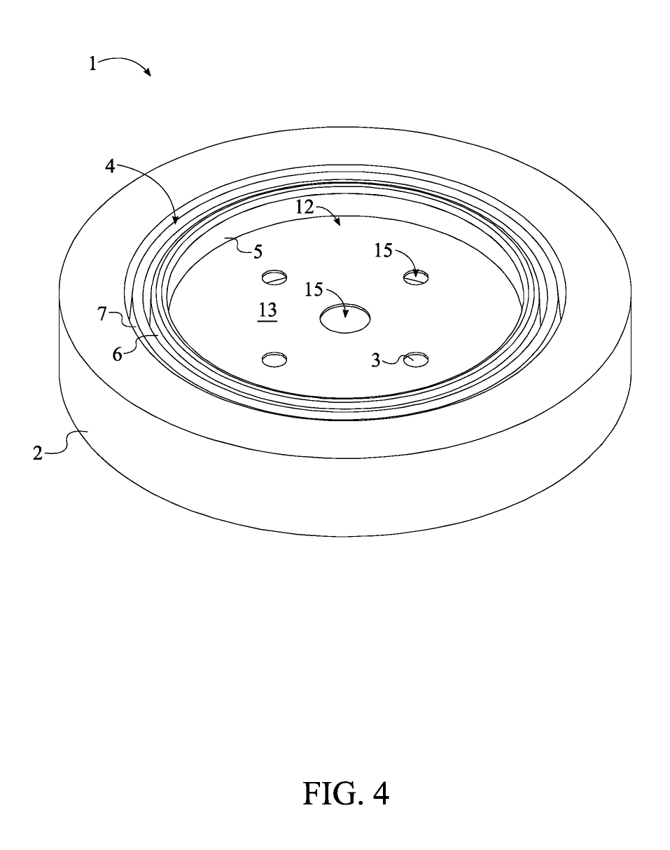

With reference to FIGS. 4 through 6, the pot body 1 may be arranged into a collapsed configuration. The collapsed configuration allows a user to access and/or remove the contents placed inside the pot body 1. In the collapsed configuration, the base 3 is encircled by the beginning pleat 5. Moreover, the preceding annular pleat is encircled by the arbitrary intermediate pleat. The arbitrary intermediate pleat is encircled by the subsequent annular pleat. Furthermore, the ending pleat 7 is encircled by the brim 2. This arrangement properly positions the parts of the pot body 1 in order for a user to access and remove the contents inside the pot body 1. A user may arrange the pot body 1 into the collapsed configuration by pushing the brim 2 down towards the base 3. Furthermore, the preceding annular pleat and the arbitrary intermediate pleat are oriented at a first acute angle 10 with each other. The arbitrary intermediate pleat and the subsequent annular pleat is oriented at a second acute angle 11 with each other. This arrangement allows each of the series of annular pleats 4 to fold into each other in order the pot body 1 to be arranged into the collapsed configuration. The first acute angle 10 and the second acute angle 11 are a pair of alternate interior angles. The first acute angle 10 and the second acute angle 11 are formed when each of the series of annular pleats 4 is folded along each other.

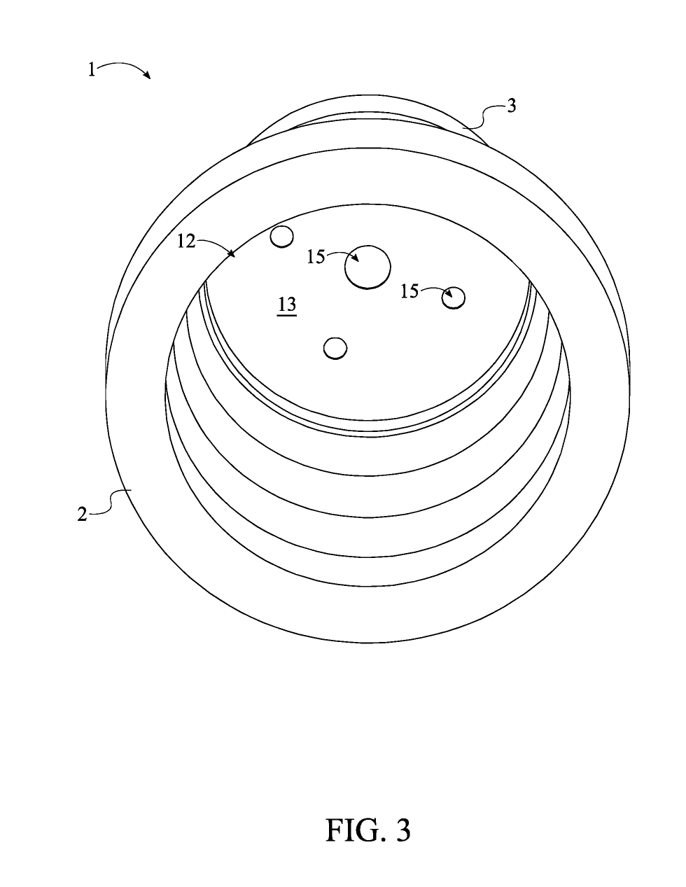

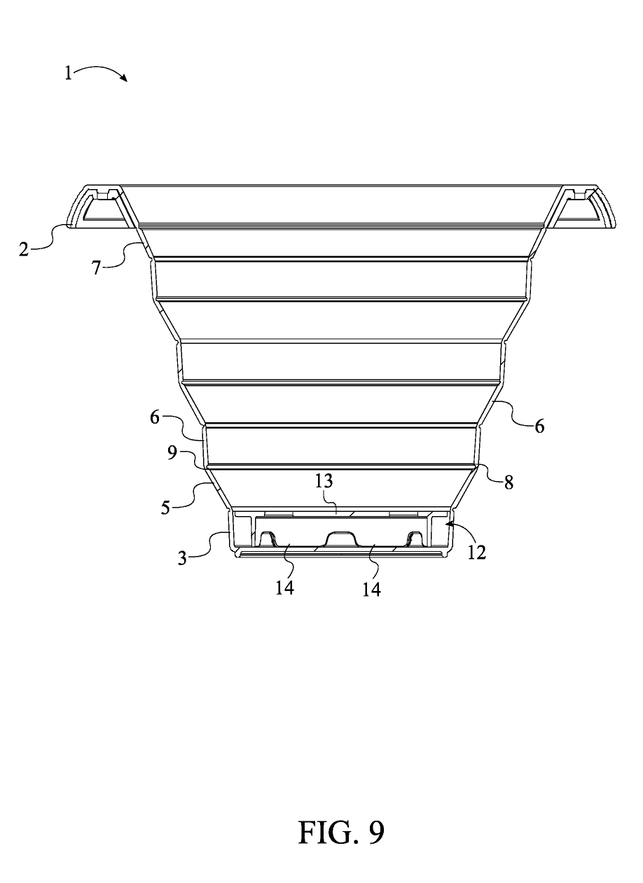

With reference to FIGS. 3 and 9, The present invention further comprises a reservoir tray 12. The reservoir tray 12 functions as a reservoir and is used to store water until the water is absorbed by the plant substance inside the pot body 1. In order for the reservoir tray 12 to accomplish this objective, the reservoir tray 12 is positioned within the pot body 1 and is attached onto the base 3. The latter arrangement allows a user to easily remove the reservoir tray 12 in order to refill the tray with water. Additionally, the arrangement of the reservoir tray 12 ensures that the reservoir is kept in place inside the pot body 1.

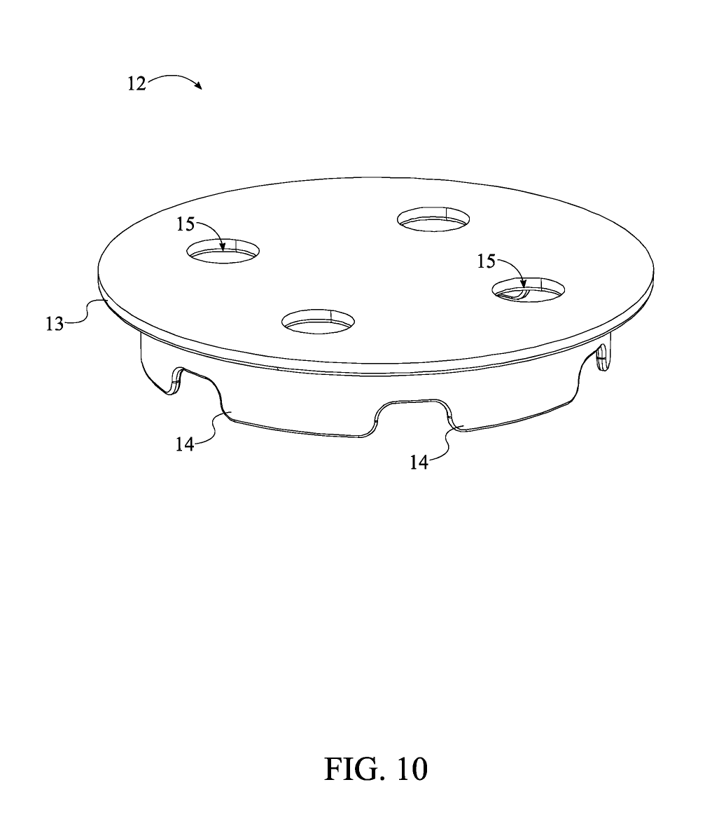

Additionally and with reference to FIGS. 9 and 10, the reservoir tray 12 comprises a platform 13, a plurality of nubs 14, and a plurality of openings 15. The platform 13 is a raised surface of the reservoir tray 12 that is used to hold the soil and plant substance placed inside the pot body 1. The plurality of nubs 14 is a set of protrusions that allows the platform 13 to be raised from a bottom surface of the base 3. The plurality of openings 15 is a set of holes that allows water to flow from the reservoir to be absorbed by the soil and plant substance placed inside the pot body 1. In order for the plurality of nubs 14 to allow the platform 13 to be raised from the base 3, the plurality of nubs 14 is connected normal to the platform 13. In order for the plurality of openings 15 to allow water to pass through the reservoir tray 12 to be absorbed by the soil and plant substance placed inside the pot body 1, the plurality of openings 15 traverses through the platform 13 and is distributed across the platform 13. The present invention may further comprise a plurality of notches. The plurality of notches is a set of slits that allows the pot body 1 to receive the reservoir tray 12. In order for the plurality of notches to allow the pot body 1 to receive the reservoir tray 12, the plurality of notches is positioned within the pot body 1 and is integrated into the base 3. Moreover, each of the plurality of notches is engaged by a corresponding nub from the plurality of nubs 14. This arrangement securely attaches the reservoir tray 12 to the pot body 1.

Although the invention has been explained in relation to its preferred embodiment, it is to be understood that many other possible modifications and variations can be made without departing from the spirit and scope of the invention as hereinafter claimed.

What is claimed is:

1. A collapsible planting pot comprises:
a pot body;
the pot body comprises a brim, a base, and a series of annular pleats;
the series of annular pleats comprises a beginning pleat, a plurality of intermediate pleats, and an ending pleat;
each of the series of annular pleats comprises a first rim and a second rim;
the first rim of the beginning pleat being perimetrically and foldably connected around the base;
the first rim of an arbitrary intermediate pleat being foldably connected along the second rim of a preceding annular pleat from the series of annular pleats, wherein the arbitrary intermediate pleat is any pleat from the plurality of intermediate pleats;
the second rim of the arbitrary intermediate pleat being foldably connected along the first rim of a subsequent annular pleat from the series of annular pleats; and
the second rim of the ending pleat being perimetrically and foldably connected around the brim.

2. The collapsible planting pot as claimed in claim 1 comprises:
wherein the pot body is arranged into an operative configuration;
the brim and the base being positioned offset from each other; and
the series of annular pleats being positioned in between the brim and the base.

3. The collapsible planting pot as claimed in claim 2 comprises:
the pot body tapering from the brim to the base.

4. The collapsible planting pot as claimed in claim 1 comprises:
wherein the pot body is arranged into a collapsed configuration;
the base being encircled by the beginning pleat;
the preceding annular pleat being encircled by the arbitrary intermediate pleat;
the arbitrary intermediate pleat being encircled by the subsequent annular pleat; and
the ending pleat being encircled by the brim.

5. The collapsible planting pot as claimed in claim 4 comprises:
the preceding annular pleat and the arbitrary intermediate pleat being oriented at a first acute angle with each other;
the arbitrary intermediate pleat and the subsequent annular pleat being oriented at a second acute angle with each other; and
the first acute angle and the second acute angle being a pair of alternate interior angles.

6. The collapsible planting pot as claimed in claim 1 comprises:
a reservoir tray;
the reservoir tray being positioned within the pot body; and
the reservoir being attached onto the base.

7. The collapsible planting pot as claimed in claim 6 comprises:
the reservoir tray comprises a platform, a plurality of nubs, and a plurality of openings;
the plurality of nubs being connected normal to the platform;
each of the plurality of nubs being positioned adjacent to the base;
the platform being positioned offset from the base;
the plurality of openings traversing through the platform; and
the plurality of openings being distributed across the platform.

8. A collapsible planting pot comprises:
a pot body;
a reservoir tray;
the pot body comprises a brim, a base, and a series of annular pleats;
the series of annular pleats comprises a beginning pleat, a plurality of intermediate pleats, and an ending pleat;
each of the series of annular pleats comprises a first rim and a second rim;
the first rim of the beginning pleat being perimetrically and foldably connected around the base;
the first rim of an arbitrary intermediate pleat being foldably connected along the second rim of a preceding annular pleat from the series of annular pleats, wherein the arbitrary intermediate pleat is any pleat from the plurality of intermediate pleats;
the second rim of the arbitrary intermediate pleat being foldably connected along the first rim of a subsequent annular pleat from the series of annular pleats;
the second rim of the ending pleat being perimetrically and foldably connected around the brim;
the reservoir tray being positioned within the pot body; and
the reservoir being attached onto the base.

9. The collapsible planting pot as claimed in claim 8 comprises:
wherein the pot body is arranged into an operative configuration;
the brim and the base being positioned offset from each other; and
the series of annular pleats being positioned in between the brim and the base.

10. The collapsible planting pot as claimed in claim 9 comprises:
the pot body tapering from the brim to the base.

11. The collapsible planting pot as claimed in claim 8 comprises:
wherein the pot body is arranged into a collapsed configuration;
the base being encircled by the beginning pleat;
the preceding annular pleat being encircled by the arbitrary intermediate pleat;
the arbitrary intermediate pleat being encircled by the subsequent annular pleat; and
the ending pleat being encircled by the brim.

12. The collapsible planting pot as claimed in claim 11 comprises:
the preceding annular pleat and the arbitrary intermediate pleat being oriented at a first acute angle with each other;
the arbitrary intermediate pleat and the subsequent annular pleat being oriented at a second acute angle with each other; and
the first acute angle and the second acute angle being a pair of alternate interior angles.

13. The collapsible planting pot as claimed in claim 8 comprises:
the reservoir tray comprises a platform, a plurality of nubs, and a plurality of openings;
the plurality of nubs being connected normal to the platform;
each of the plurality of nubs being positioned adjacent to the base;
the platform being positioned offset from the base;
the plurality of openings traversing through the platform; and
the plurality of openings being distributed across the platform.

14. A collapsible planting pot comprises:
a pot body;
a reservoir tray;
the pot body comprises a brim, a base, and a series of annular pleats;
the series of annular pleats comprises a beginning pleat, a plurality of intermediate pleats, and an ending pleat;
each of the series of annular pleats comprises a first rim and a second rim;
the reservoir tray comprises a platform, a plurality of nubs, and a plurality of openings;
the first rim of the beginning pleat being perimetrically and foldably connected around the base;
the first rim of an arbitrary intermediate pleat being foldably connected along the second rim of a preceding annular pleat from the series of annular pleats, wherein the arbitrary intermediate pleat is any pleat from the plurality of intermediate pleats;
the second rim of the arbitrary intermediate pleat being foldably connected along the first rim of a subsequent annular pleat from the series of annular pleats;
the second rim of the ending pleat being perimetrically and foldably connected around the brim;
the reservoir tray being positioned within the pot body;
the reservoir being attached onto the base;
the plurality of nubs being connected normal to the platform;
each of the plurality of nubs being positioned adjacent to the base;
the platform being positioned offset from the base;
the plurality of openings traversing through the platform; and
the plurality of openings being distributed across the platform.

15. The collapsible planting pot as claimed in claim 14 comprises:
wherein the pot body is arranged into an operative configuration;
the brim and the base being positioned offset from each other; and
the series of annular pleats being positioned in between the brim and the base.

16. The collapsible planting pot as claimed in claim 15 comprises:
the pot body tapering from the brim to the base.

17. The collapsible planting pot as claimed in claim 14 comprises:
wherein the pot body is arranged into a collapsed configuration;
the base being encircled by the beginning pleat;
the preceding annular pleat being encircled by the arbitrary intermediate pleat;
the arbitrary intermediate pleat being encircled by the subsequent annular pleat; and
the ending pleat being encircled by the brim.

18. The collapsible planting pot as claimed in claim 17 comprises:
the preceding annular pleat and the arbitrary intermediate pleat being oriented at a first acute angle with each other;
the arbitrary intermediate pleat and the subsequent annular pleat being oriented at a second acute angle with each other; and
the first acute angle and the second acute angle being a pair of alternate interior angles.
